(19) United States
(12) Patent Application Publication
(10) Pub. No.: US 2024/0421494 A1
(43) Pub. Date: Dec. 19, 2024

(54) BASE STATION ANTENNAS HAVING COMPACT DUAL-POLARIZED BOX DIPOLE RADIATING ELEMENTS THEREIN THAT SUPPORT HIGH BAND CLOAKING

(71) Applicant: Outdoor Wireless Networks LLC, Claremont, NC (US)

(72) Inventors: Bin Sun, Suzhou (CN); Jian Zhang, Suzhou (CN); Changfu Chen, Suzhou (CN); Cheng Xue, Suzhou (CN); Pengfei Guo, Suzhou (CN)

(21) Appl. No.: 18/735,673

(22) Filed: Jun. 6, 2024

(30) Foreign Application Priority Data
Jun. 14, 2023 (CN) 202321515249.7

(51) Int. Cl. H01Q 9/26; H01Q 1/24; H01Q 1/50

(52) U.S. Cl. CPC H01Q 9/26; H01Q 1/50; H01Q 1/246

(57) ABSTRACT

A box dipole radiating element includes first, second, third and fourth pairs of support stalks, and a box-shaped radiator attached to the first through fourth pairs of support stalks. The box-shaped radiator has first through fourth sides including respective first through fourth radiating arms that are configured to provide generally serpentine-shaped paths for radiation currents in first through fourth vertical planes, which are aligned with the radiating arms and intersect at corners of the box-shaped radiator.

### FIELD OF THE INVENTION

The present invention relates to radio communications and antennas and, more particularly, to dual-polarized antennas for cellular communications and methods of operating same.

### BACKGROUND

Cellular communications systems are well known in the art. In a typical cellular communications system, a geographic area is often divided into a series of regions that are commonly referred to as “cells”, which are served by respective base stations. Each base station may include one or more base station antennas (BSAs) that are configured to provide two-way radio frequency (“RF”) communications with mobile subscribers that are within the cell served by the base station. In many cases, each base station is divided into “sectors.” In perhaps the most common configuration, a hexagonally shaped cell is divided into three 120® sectors, and each sector is served by one or more base station antennas, which generate radiating patterns (a/k/a “antenna beams”) that have an azimuth Half Power Beam Width (HPBW) of approximately 65° to thereby provide sufficient coverage to each 120° sector. Typically, the base station antennas are mounted on a tower or other raised structure and the antenna beams are directed outwardly therefrom. Base station antennas typically include one or more linear or planar phased arrays of radiating elements.

In order to accommodate an increasing volume of cellular communications, cellular operators have added cellular service in a variety of frequency bands. While in some cases it is possible to use a single linear array of so-called “wide-band” radiating elements to provide service in multiple frequency bands, in other cases it may be necessary to use different linear arrays of radiating elements in multi-band base station antennas to support service in the additional frequency bands.

One conventional multi-band base station antenna design includes at least one linear array of relatively “low-band” radiating elements, which can be used to provide service in some or all of a 617-960 MHz frequency band. In addition, to reduce costs and provide for more compact antennas, some or all of these “low-band” radiating elements may be configured to surround a corresponding relatively “high-band” radiating element that is used to provide service in some or all of a 1695-2690 MHz frequency band.

A conventional box dipole radiating element may include four dipole radiators that are arranged to define a box-like shape. The four dipole radiators may extend in a common plane, and may be mounted forwardly of a reflector that may (but need not) extend parallel to the common plane. So called feed stalks may be used to mount the four dipole radiators forwardly from the reflector, and may be used to pass RF signals between the dipole radiators and other components of the antenna. In some of these conventional box dipole radiating elements, a total of eight feed stalks (4×2) may be provided and may connect to the box dipole radiators at the corners of the box.

For example, as illustrated by FIGS. 1A-1B, a conventional multi-band radiator 10 for a base station antenna may include a relatively high band radiating element 10a centered within and surrounded on four sides by a relatively low band radiating element 10b, which is configured as a box dipole radiating element (“box dipole”) including four dipole radiators that are arranged to define a box shape when viewed from the front. RF signals may be fed to the four dipole radiators of a conventional box dipole radiating element 10b through the feed stalks at two opposed and “excited” corners of the “box,” as is shown in FIG. 1A. In response, common mode (CM) currents are forced automatically onto the feed stalks at the two diametrically opposed non-excited corners of the box dipole, in response to differential mode (DM) currents that are fed to the two excited “differential mode” ports. And, because these common mode currents radiate as a monopole on these “non-excited” feed stalks, the overall radiation pattern of the box dipole 10b is actually a combination of two dipoles and two monopoles (with “nulls”), as illustrated by the simplified radiation patterns of FIG. 1B. Unfortunately, the radiation stemming from monopole operation can be highly undesirable when designing a box dipole radiator. For example, although having common mode currents radiating at the same time with differential mode currents in the box dipole 10b can be expected to slightly narrow the azimuth HPBW of the box dipole 10b because of the presence of two nulls caused by the monopole radiators, a concurrent co-polarization radiation pattern of the box dipole 10b can be expected to demonstrate rising “shoulders” in the radiation pattern, which refer to radiation emitted outside the main lobe in the azimuth plane. These shoulders can significantly degrade overall antenna performance.

Attempts have been made to reduce these potentially adverse characteristics of conventional box dipole radiating elements. For example, as disclosed in commonly assigned PCT Patent Publication No. WO 2020/197849 A1, built-in stalk filters may be utilized to block unwanted common mode (i.e., monopole) radiation parasitics. And, in commonly assigned PCT Patent Publication No. WO 2020/205228 A1, slanted feed paths may be utilized to suppress common mode radiation. Finally, in commonly assigned PCT Patent Publication No. WO 2022/072148 A1, a box dipole radiating element is disclosed, which uses a compact quad arrangement of substantially coplanar radiating arms to generate radiation patterns having reduced “shoulders” located outside the main lobe in the azimuth plane.

### SUMMARY OF THE INVENTION

A compact, box dipole, radiating element of a base station antenna may support relatively low-band slant-polarized radiation, with relatively high band cloaking using periodic radiating arms. According to some embodiments of the invention, a box dipole radiating element is provided with at least one support stalk, and a box-shaped radiator attached to the at least one support stalk. The box-shaped radiator has first through fourth sides including respective first through fourth radiating arms that are configured to provide periodic and generally serpentine-shaped paths for radio-frequency (RF) radiation currents. Advantageously, these radiation currents are provided in first through fourth vertical planes, which are aligned with the radiating arms and intersect at corners of the box-shaped radiator.

In additional embodiments of the invention, the generally serpentine-shaped paths in the radiating arms have a repeating periodic shape, such as a generally square sinusoidal shape. In addition, the generally serpentine-shaped paths may include a plurality of forward-projecting generally T-shaped stubs, and a plurality of rearward-projecting generally T-shaped stubs. To reduce costs, the first through fourth radiating arms may be made from stamped sheet metal; however, in alternative embodiments, the first through fourth radiating arms may be formed using dual-sided printed circuit boards (PCBs) having patterned metal traces on both sides thereof.

According to further embodiments of the invention, the at least one support stalk is configured as first, second, third and fourth pairs of support stalks; the first radiating arm has a first end galvanically or capacitively coupled to a first one of the support stalks in the first pair, and a second end galvanically or capacitively coupled to a second one of the support stalks in the second pair; the second radiating arm has a first end galvanically or capacitively coupled to a first one of the support stalks in the second pair, and a second end galvanically or capacitively coupled to a second one of the support stalks in the third pair; the third radiating arm has a first end galvanically or capacitively coupled to a first one of the support stalks in the third pair, and a second end galvanically or capacitively coupled to a second one of the support stalks in the fourth pair; and the fourth radiating arm has a first end galvanically or capacitively coupled to a first one of the support stalks in the fourth pair, and a second end galvanically or capacitively coupled to a second one of the support stalks in the first pair. A support stalk base may also be provided, which is attached to proximal ends of the first, second, third and fourth pairs of support stalks. In some instances, the support stalk base and the first, second, third and fourth pairs of support stalks are formed as a unitary piece of stamped and bent sheet metal.

According to another embodiment of the invention, a first coaxial feed cable is provided and mounted to the first pair of support stalks, such that a center conductor within the first coaxial feed cable is electrically connected to the first one of the support stalks within the first pair and a shield conductor within the first coaxial feed cable is electrically connected to the second one of the support stalks within the first pair; a second coaxial feed cable is provided and mounted to the second pair of support stalks, such that a center conductor within the second coaxial feed cable is electrically connected to the first one of the support stalks within the second pair and a shield conductor within the second coaxial feed cable is electrically connected to the second one of the support stalks within the second pair; a third coaxial feed cable is provided and mounted to the third pair of support stalks, such that a center conductor within the third coaxial feed cable is electrically connected to the first one of the support stalks within the third pair and a shield conductor within the third coaxial feed cable is electrically connected to the second one of the support stalks within the third pair; and a fourth coaxial feed cable is provided and mounted to the fourth pair of support stalks, such that a center conductor within the fourth coaxial feed cable is electrically connected to the first one of the support stalks within the fourth pair and a shield conductor within the fourth coaxial feed cable is electrically connected to the second one of the support stalks within the fourth pair. Moreover, in some of these embodiments, the first, second, third, and fourth coaxial feed cables are mounted to the second ones of the support stalks within the first, second, third and fourth pairs, adjacent generally L-shaped bends therein. For example, the shield conductor in the first coaxial feed cable may be soldered to an opening in the second one of the support stalks within the first pair, whereas the center conductor within the first coaxial feed cable may extend through the opening in the second one of the support stalks within the first pair. The same also applies to the second, third and fourth coaxial feed cables and their corresponding pairs of support stalks.

According to still further embodiments of the invention, a multi-band antenna is provided, which includes a reflector and a first radiating element on a forward facing surface of the reflector. The first radiating element may include a support stalk base on the forward-facing surface of the reflector, and first, second, third and fourth pairs of support stalks mounted to and extending forwardly from the support stalk base. First, second, third and fourth coaxial feed signal cables are provided, which are mounted to the first, second, third and fourth pairs of support stalks, respectively, adjacent generally L-shaped bends therein. A box-shaped radiator is provided, which is attached to the first through fourth pairs of support stalks. The box-shaped radiator has first through fourth sides including respective first through fourth radiating arms. These first through fourth radiating arms are configured to provide nonlinear paths for radiation currents in first through fourth vertical planes, which are aligned with the radiating arms and intersect at corners of the box-shaped radiator. Moreover, to increase the integration of radiating elements on the reflector, a smaller second radiating element may be provided, which extends through an opening in the support stalk base and is nested between the first through fourth pairs of support stalks. In some embodiments, this second radiating element may be configured to operate in a second frequency band that is higher than a first frequency band associated with the radiation currents.

### BRIEF DESCRIPTION OF THE DRAWINGS

FIG. 1A is a schematic diagram of a conventional box dipole radiating element that includes a partial perspective view of the box dipole radiating element showing simulated differential mode and common mode currents therein, according to the prior art and a schematic front view of the box dipole radiating element.

FIG. 1B illustrates radiation patterns of a dipole antenna having a differential mode (DM) and a monopole antenna having a common mode (CM), which when combined together provide a radiation pattern of a conventional box dipole antenna.

FIG. 2A is a top-down plan view of a box dipole radiating element according to an embodiment of the invention.

FIG. 2B is a perspective view of an embodiment of the box dipole radiating element of FIG. 2A.

FIG. 2C is a side view of an embodiment of the box dipole radiating element of FIG. 2A.

FIG. 2D is a side view of a sheet metal radiating arm that supports a serpentine-shaped path for radiation currents therein, according to the embodiment of FIG. 2C.

FIG. 3A is a perspective view of a box dipole radiating element, according to an embodiment of the invention.

FIG. 3B is an enlarged perspective view of a highlighted region “3B” in the box dipole radiating element of FIG. 3A, which illustrates how a coaxial feed cable can be mounted and electrically coupled to a corresponding pair of support stalks, according to an embodiment of the invention.

FIG. 4A is a perspective view of a sheet metal radiating arm that supports a serpentine-shaped path for radiation currents therein, which may be utilized within the box dipole radiating element of FIG. 2A.

FIG. 4B is a perspective view of a printed circuit board (PCB) radiating arm that supports a serpentine-shaped path for radiation currents therein, which may be utilized within the box dipole radiating element of FIG. 2A.

FIG. 5A is a perspective view of a multi-band antenna having an array of the box dipole radiating elements of FIG. 2A therein, according to an embodiment of the invention.

FIG. 5B is a plan view of the multi-band antenna of FIG. 5A.

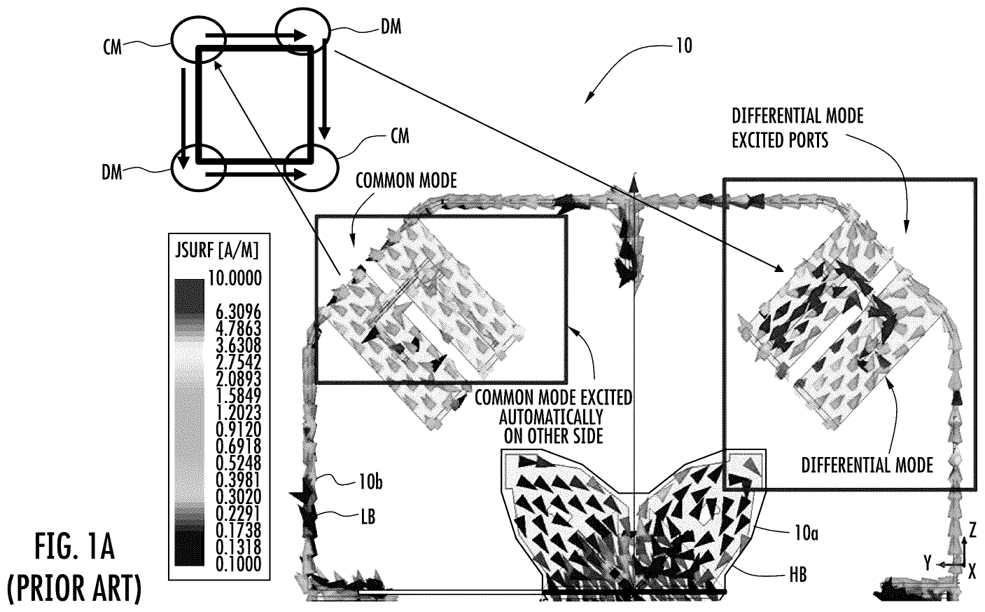

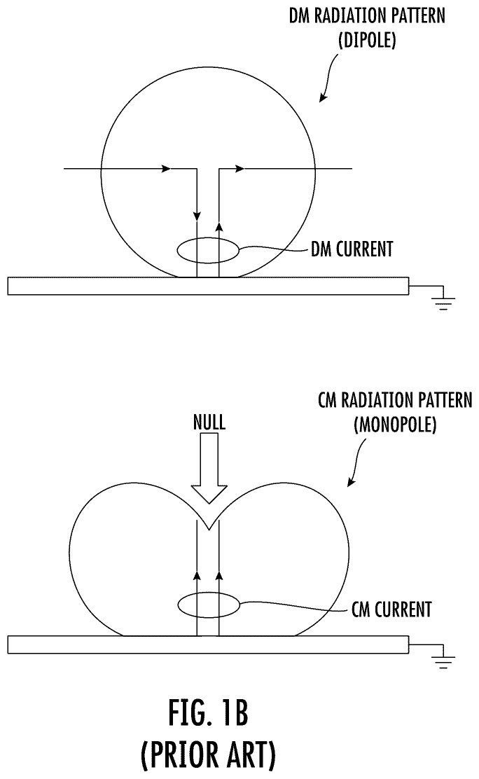

### DETAILED DESCRIPTION OF EMBODIMENTS

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

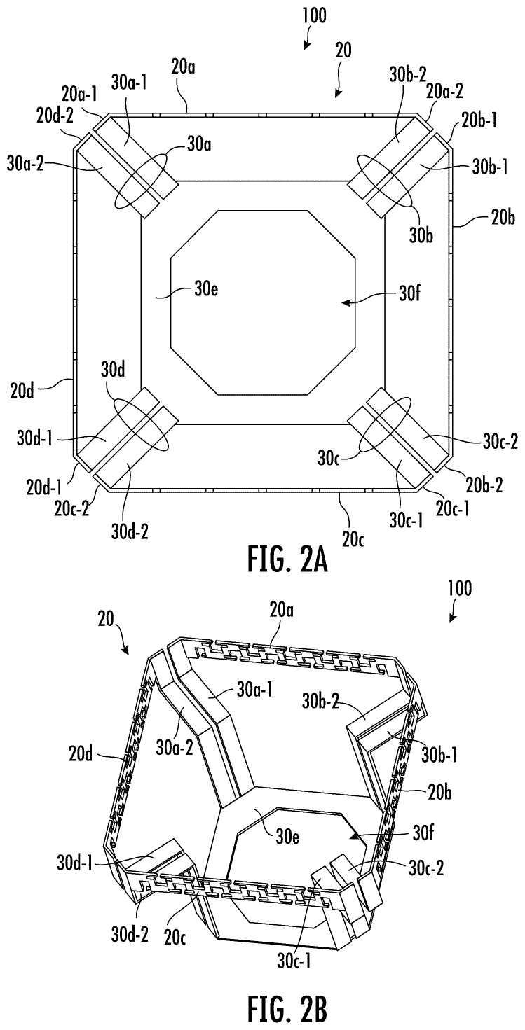

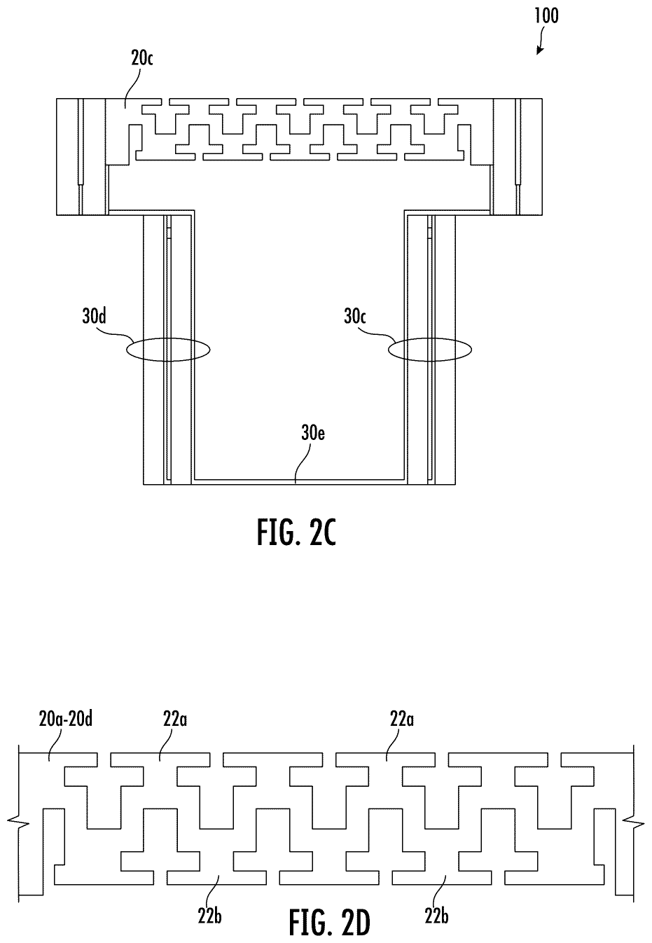

Referring now to FIGS. 2A-2D, a cloaked box dipole radiating element 100 that supports relatively low-band slant-polarized radiation includes first, second, third and fourth pairs of support stalks 30a-30d and a box-shaped radiator 20, which is attached, at four corners, to forward-extending distal ends of the four pairs of support stalks 30a-30d, as shown. In addition, first through fourth sides of the box-shaped radiator 20 are defined by respective first through fourth radiating arms 20a-20d, which are configured to provide periodic and generally serpentine-shaped paths for radio-frequency (RF) radiation currents in first through fourth vertical planes; these vertical planes are aligned with the radiating arms 20a-20d and intersect at corners of the box-shaped radiator 20. Advantageously, the generally serpentine-shaped paths facilitate a radiating element 100 having compact size and excellent relatively high band cloaking characteristics, while maintaining sufficient electrical length of the radiating arms 20a-20d.

As shown best by FIGS. 2A-2B, the first radiating arm 20a has a first end 20a-1 electrically coupled to a first one of the support stalks in the first pair 30a-1, and a second end 20a-2 electrically coupled to a second one of the support stalks in the second pair 30b-2. Similarly, the second radiating arm 20b has a first end 20b-1 electrically coupled to a first one of the support stalks in the second pair 30b-1, and a second end 20b-2 electrically coupled to a second one of the support stalks in the third pair 30c-2. And, the third radiating arm 20c has a first end 20c-1 electrically coupled to a first one of the support stalks in the third pair 30c-1, and a second end 20c-2 electrically coupled to a second one of the support stalks in the fourth pair 30d-2. Finally, the fourth radiating arm 20d has a first end 20d-1 electrically coupled to a first one of the support stalks in the fourth pair 30d-1, and a second end 20d-2 electrically coupled to a second one of the support stalks in the first pair 30a-2. In some embodiments of the invention, the electrical coupling between the support stalks 30a-30d and the radiating arms 20a-20d may take the form of galvanic connections, or capacitive coupling using thin dielectric layers (not shown) extending between the ends of the arms and corresponding support stalks. Moreover, because of the generally box-shaped configuration of the radiating element 100, an inner surface of the first radiating arm 20a faces an inner surface of the third radiating arm 20c, and an inner surface of the second radiating arm 20b faces an inner surface of the fourth radiating arm 20d, as shown best by FIG. 2A.

According to some embodiments of the invention, a generally square-shaped and electrically conductive support stalk base 30e, having an opening 30f therein, may be provided for improved structural integrity and mounting support (e.g., on an underlying reflector), and to provide electrical paths for RF currents (e.g., common-mode (CM), differential-mode (DM)). As shown, this support stalk base 30e is attached, at corners, to proximal ends of the first, second, third and fourth pairs of support stalks 30a-30d. Although not wishing to be bound by any particular configuration or means of assembly, the support stalk base 30e and the first, second, third and fourth pairs of support stalks 30a-30d may be formed as a unitary piece of stamped and bent sheet metal in some embodiments; however, in other configurations, a unitary piece of dielectric material (e.g., plastic, dielectric board) having metal surfaces thereon (e.g., patterned traces, electroplated surfaces) may be used.

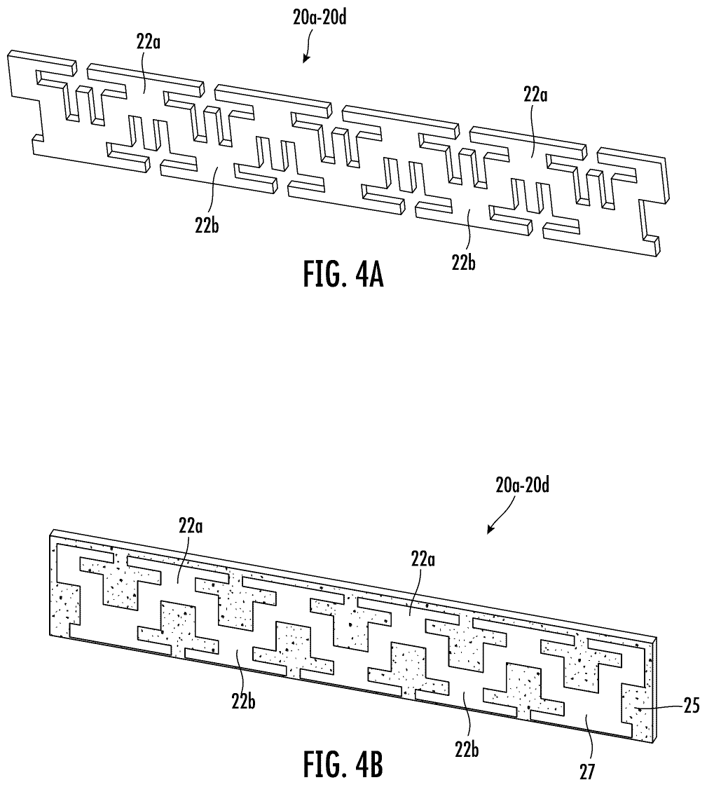

Referring again to FIGS. 2C-2D and to FIG. 4A, the first through fourth radiating arms 20a-20d are configured to have a generally square sinusoidal shape (for RF current flow) and include a plurality of forward-projecting generally T-shaped stubs 22a and a plurality of rearward-projecting generally T-shaped stubs 22b, which can advantageously curb relatively high band radiation by influencing current flow direction within the sinusoidal shape. And, according to some embodiments of the invention, these first through fourth radiating arms 20a-20d may be made from stamped sheet metal. However, as shown by FIG. 4B, each of the radiating arms 20a-20b may alternatively be formed as a dual-sided printed circuit board (PCB) 25 having patterned metal traces 27 thereon, which define the generally square sinusoidal shape shown by FIG. 4A, or as shown by FIG. 2D, etc.

According to further embodiments of the invention, the four pairs of support stalks 30a-30d may be configured to provide RF signal paths for a pair of cross-polarized dipole feed signals (e.g., Feed 1 (0°, 180°) at +45°, and Feed 2 (0°, 180°) at −45°), which can be supplied by four coaxial feed cables, for example. As will be understood by those skilled in the art, the feed signals Feed 1 and Feed 2 may be generated by passing an RF input signal through a power divider (not shown) that splits the RF input signal into substantially equal magnitude, equal phase RF signals that constitute Feed 1 and Feed 2.

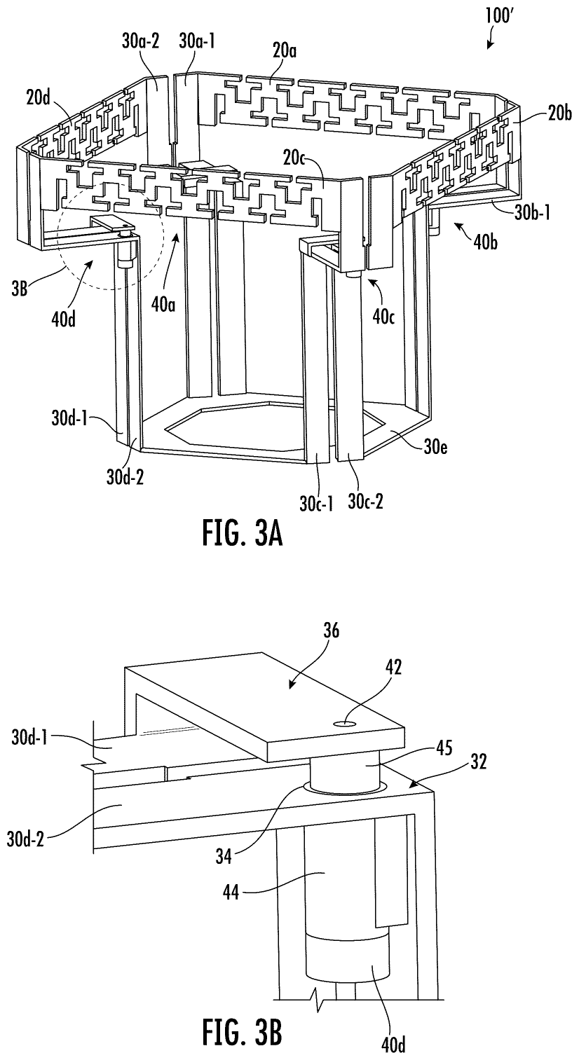

In particular, as shown by the radiating element 100′ of FIGS. 3A-3B, a first coaxial feed cable 40a may be mounted to the first pair of support stalks 30a, such that: (i) a center conductor 42 within the first coaxial feed cable 40a is electrically connected to the first one of the support stalks within the first pair 30a-1, and (ii) a surrounding shield conductor 44 within the first coaxial feed cable 40a is electrically connected to the second one of the support stalks within the first pair 30a-2. Likewise, a second coaxial feed cable 40b may be mounted to the second pair of support stalks 30b, such that: (i) a center conductor 42 within the second coaxial feed cable 40b is electrically connected to the first one of the support stalks within the second pair 30b-1, and (ii) a surrounding shield conductor 44 within the second coaxial feed cable 40b is electrically connected to the second one of the support stalks within the second pair 30b-2. Similarly, a third coaxial feed cable 40c may be mounted to the third pair of support stalks 30c, such that: (i) a center conductor 42 within the third coaxial feed cable 30c is electrically connected to the first one of the support stalks within the third pair 30c-1, and (ii) a surrounding shield conductor 44 within the third coaxial feed cable 40c is electrically connected to the second one of the support stalks within the third pair 30c-2. Finally, a fourth coaxial feed cable 40d may be mounted to the fourth pair of support stalks 30d, such that: (i) a center conductor 42 within the fourth coaxial feed cable 40d is electrically connected to the first one of the support stalks within the fourth pair 30d-1, and (ii) a surrounding shield conductor 44 within the fourth coaxial feed cable 40d is electrically connected to the second one of the support stalks within the fourth pair 30d-2.

Moreover, as illustrated by FIG. 3B, which is an enlarged perspective view of a highlighted region “3B” in the box dipole radiating element of FIG. 3A, the fourth coaxial feed cable 40d can be mounted to the second one of the support stalks within the fourth pair 30d-2, adjacent a generally L-shaped bend 32 therein. For example, this mounting can be performed by soldering the shield conductor 44 within the fourth coaxial feed cable 40d into an opening 34 in the second one of the support stalks within the fourth pair 30d-2, and extending a center conductor 42 (and cable insulation 45) within the fourth coaxial feed cable 40d through the opening 34 in the second one of the support stalks within the fourth pair 30d-2, such that a direct electrical connection can be formed (e.g., by solder) between the center conductor 42 and an L-shaped electrically conductive tab 36 (e.g., bent sheet metal) extending from the first one of the support stalks within the fourth pair 30d-1. Similar mounting operations may also be utilized to mount the first, second and third coaxial cables 40a-40c to the first, second and third pairs of support stalks 30a-30c, respectively.

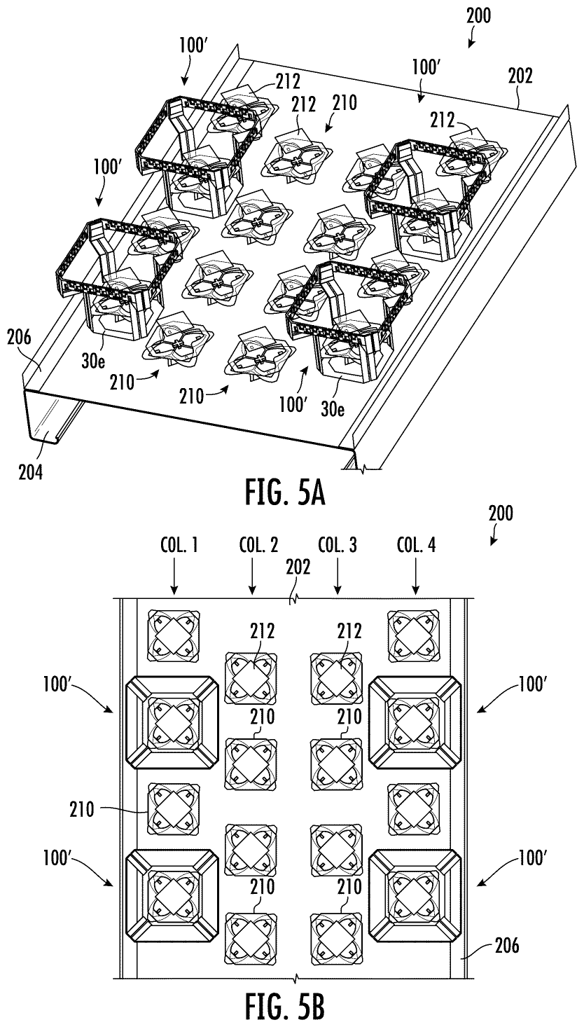

Referring now to FIGS. 5A-5B, a multi-band antenna 200 according to an embodiment of the invention is illustrated as including: (i) a reflector 202 with rear-facing RF chokes 204 and pair of L-shaped fences 206, (ii) a quad arrangement of the relatively low band (LB) radiating element 100′ of FIGS. 3A-3B, which is aligned with first and fourth columns (Col. 1, Col. 4) of the antenna 200, and (iii) sixteen relatively high band (HB) radiating elements 210 (with directors 212), which are arranged into four columns (Cols. 1-4) having four rows per column. As shown, eight HB radiating elements 210 in the second and third columns (Col. 2, Col. 3) may be offset relative to eight HB radiating elements 210 in the first and fourth columns. In addition, two HB radiating elements 210 in the first column and two HB radiating elements 210 in the fourth column may be “nested” within corresponding openings in the support stalk bases 30e of four corresponding LB radiating elements 100′, as shown.

In the drawings and specification, there have been disclosed typical preferred embodiments of the invention and, although specific terms are employed, they are used in a generic and descriptive sense only and not for purposes of limitation, the scope of the invention being set forth in the following claims.

1. A box dipole radiating element, comprising:
at least one support stalk; and
a box-shaped radiator attached to the at least one support stalk, said box-shaped radiator having first through fourth sides comprising respective first through fourth radiating arms that are configured to provide generally serpentine-shaped paths for radiation currents in first through fourth vertical planes, which are aligned with the radiating arms and intersect at corners of the box-shaped radiator.

2. The radiating element of claim 1, wherein the generally serpentine-shaped paths in the radiating arms have a repeating periodic shape.

3. The radiating element of claim 2, wherein the generally serpentine-shaped paths in the radiating arms have a generally square sinusoidal shape.

4. The radiating element of claim 3, wherein the generally serpentine-shaped paths include a plurality of forward-projecting generally T-shaped stubs and a plurality of rearward-projecting generally T-shaped stubs.

5. The radiating element of claim 1, wherein the generally serpentine-shaped paths include a plurality of forward-projecting generally T-shaped stubs and a plurality of rearward-projecting generally T-shaped stubs.

6. The radiating element of claim 5, wherein the first through fourth radiating arms are made from stamped sheet metal.

7. The radiating element of claim 5, wherein the first through fourth radiating arms comprise respective dielectric boards having patterned metal traces thereon.

8. The radiating element of claim 1,
wherein the at least one support stalk comprises first, second, third and fourth pairs of support stalks;
wherein the first radiating arm has a first end electrically coupled to a first one of the support stalks in the first pair, and a second end electrically coupled to a second one of the support stalks in the second pair;
wherein the second radiating arm has a first end electrically coupled to a first one of the support stalks in the second pair, and a second end electrically coupled to a second one of the support stalks in the third pair;
wherein the third radiating arm has a first end electrically coupled to a first one of the support stalks in the third pair, and a second end electrically coupled to a second one of the support stalks in the fourth pair; and
wherein the fourth radiating arm has a first end electrically coupled to a first one of the support stalks in the fourth pair, and a second end electrically coupled to a second one of the support stalks in the first pair.

9. The radiating element of claim 8, further comprising a support stalk base attached to proximal ends of the first, second, third and fourth pairs of support stalks.

10. The radiating element of claim 9, wherein the support stalk base and the first, second, third and fourth pairs of support stalks are formed as a unitary piece of stamped and bent sheet metal.

11. The radiating element of claim 9, further comprising first, second, third and fourth coaxial feed cables mounted to the first, second, third and fourth pairs of support stalks, respectively.

12. The radiating element of claim 8, wherein the first end of the first radiating arm is galvanically connected to the first one of the support stalks in the first pair.

13. The radiating element of claim 8, wherein the first end of the first radiating arm is capacitively coupled to the first one of the support stalks in the first pair.

14. The radiating element of claim 1, wherein an inner surface of the first radiating arm faces an inner surface of the third radiating arm, and an inner surface of the second radiating arm faces an inner surface of the fourth radiating arm.

15. The radiating element of claim 8, further comprising:
a first coaxial feed cable mounted to the first pair of support stalks, such that a center conductor within the first coaxial feed cable is electrically connected to the first one of the support stalks within the first pair and a shield conductor within the first coaxial feed cable is electrically connected to the second one of the support stalks within the first pair;
a second coaxial feed cable mounted to the second pair of support stalks, such that a center conductor within the second coaxial feed cable is electrically connected to the first one of the support stalks within the second pair and a shield conductor within the second coaxial feed cable is electrically connected to the second one of the support stalks within the second pair;
a third coaxial feed cable mounted to the third pair of support stalks, such that a center conductor within the third coaxial feed cable is electrically connected to the first one of the support stalks within the third pair and a shield conductor within the third coaxial feed cable is electrically connected to the second one of the support stalks within the third pair; and
a fourth coaxial feed cable mounted to the fourth pair of support stalks, such that a center conductor within the fourth coaxial feed cable is electrically connected to the first one of the support stalks within the fourth pair and a shield conductor within the fourth coaxial feed cable is electrically connected to the second one of the support stalks within the fourth pair.

16. The radiating element of claim 15, wherein the first coaxial feed cable is mounted to the second one of the support stalks within the first pair, adjacent a generally L-shaped bend therein.

17. The radiating element of claim 16, wherein the shield conductor in the first coaxial feed cable is soldered to an opening in the second one of the support stalks within the first pair.

18. The radiating element of claim 17, wherein the center conductor within the first coaxial feed cable extends through the opening in the second one of the support stalks within the first pair.

19. The radiating element of claim 1, wherein the first through fourth radiating arms comprise metal having the following shape: [symbol]
when the radiating element is viewed from a side perspective.

20. The radiating element of claim 1, wherein the first through fourth radiating arms comprise metal having the following shape: [symbol]
when the radiating element is viewed from a side perspective.

21.-24. (canceled)
